(19) United States
(12) Patent Application Publication
(10) Pub. No.: US 2013/0138561 A1
(43) Pub. Date: May 30, 2013

(54) METHOD AND SYSTEM FOR CROSS-BORDER STORED VALUE PAYMENT

(71) Applicant: William Chi Yuen Chan, Singapore (SG)

(72) Inventor: William Chi Yuen Chan, Singapore (SG)

(21) Appl. No.: 13/307,481

(22) Filed: Nov. 30, 2011

(51) Int. Cl. G06Q 40/00; G06F 15/16

(52) U.S. Cl. 705/41; 709/217

(57) ABSTRACT

Methods and systems for provisioning data to a mobile device operable as a contactless payment device, the data including currency location data; receiving a notification that the mobile device is operating in a second currency location; and sending updated currency location data to the mobile device based on the second currency location. Some methods and systems include receiving, at a mobile device operable as a contactless payment device, currency location data associated with a first currency location; receiving updated currency location data associated with a second currency location by the mobile device located at the second currency location; and updating values for currency location data parameters of the mobile device based on the updated currency location data.

### BACKGROUND

The use of credit cards, debit cards, stored values cards, electronic wallets, and other means of payment relying on payment account numbers as opposed to cash is ever-increasing among consumers. In some contexts, the proliferation of paperless payment transactions is becoming a preferred method of conducting many types of payment transactions, including small purchase amount transactions as well as larger purchases. The convenience of paperless payment transactions is attractive to many account holders.

Proximity payment devices (otherwise referred to herein as contactless payment cards or devices), such as the PayPass® payment device issued pursuant to standards developed by MasterCard International Incorporated, are becoming more widely used. PayPass® proximity payment devices (as well as a number of other proximity payment device schemes) follow standards, such as ISO standards and the EMV standards (available at www.emvco.com). The EMV standards set forth a security infrastructure in which payment device issuers create secure keys that are used to uniquely identify payment devices issued by them.

In a number of contexts, stored value cards are very popular with consumers and service providers of those types of payment devices. For example, the use of stored value cards is highly encouraged and widely accepted in some transit systems in various countries around the world. While stored value cards are conveniently used at transit locations such as kiosks and entry/exit gates and other retail locations, a constraint on the use of such payment devices is that they are limited to one currency. That is, the currency of the stored value stored on the card is fixed and such payment devices cannot be used in other regions or countries having a currency different than the currency of the stored value card.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, wherein:

FIG. 1 is an illustrative depiction of a system, according to some embodiments herein;

FIG. 2 is a flow diagram illustrating a process, according to some embodiments herein;

FIG. 3 is flow diagram of a process, in accordance with some embodiments herein;

FIG. 4 flow diagram illustrates a process, in accordance with some embodiments herein;

FIG. 5 is schematic block diagram of an apparatus, according to some embodiments herein and

FIG. 6 is schematic block diagram of an apparatus, according to some embodiments herein.

### DETAILED DESCRIPTION

For simplicity and ease of exposition, a number of terms are used herein. For example, the terms “proximity payment device”, “payment device”, “payment card”, “contactless payment device”, or “contactless payment card” are used to refer to payment devices that use either radio frequency or infrared technology to allow a device to communicate with a terminal to conduct a payment transaction. For example, the terms may be used to refer to devices that are compliant with ISO/IEC 14443 Standard, ISO/IEC 18000 standard, or the NFC standards including ISO/IEC 18092/ECMA 340 and ISO/IEC 21481/ECMA 352. As a particular example, a “proximity payment device” may be further compliant with both the ISO/IEC 14443 Standard and the “PayPass” standards promulgated by MasterCard International Incorporated. In some embodiments, a proximity payment device or contactless payment device herein may adhere to other standards, if any, other than those particularly listed here. A proximity payment device may have any of number of form factors. For example, a device may be configured in the shape of a traditional credit card (with an antenna and one or more chips embedded in a substrate) or a mobile computing device such as a mobile phone including a RFID or NFC chip.

As used herein, the term “reader” or “terminal” is used to refer to a proximity coupling device that is capable of interrogating and reading data from a proximity payment device. In some embodiments, the reader may be incorporated into, or part of, the terminal. In some embodiments, the reader may be separate from (but in communication with) the terminal. A number of different types of terminals may be used, including, for example, traditional point of sale (“POS”) terminals having contactless readers, computing devices (such as personal computers, handheld computers, or the like), etc.

In general, and for the purpose of introducing concepts of embodiments of the present disclosure, a stored value payment device refers to a payment device (e.g., card, mobile telephone, etc.) that stores the funds available for use in a payment transaction on the payment device. The stored value payment device may complete a purchase transaction offline by exchanging data including the available funds amount(s) stored on the payment device with a point of sale (i.e., a POS) terminal or other reader device, application, or service. In some embodiments, the value of the available funds may be accessed using a contact-based (e.g., a magnetic stripe on a card, etc.) or a contactless embodiment (e.g., using radio-frequency identification (RFID), near field communication (NFC), etc.).

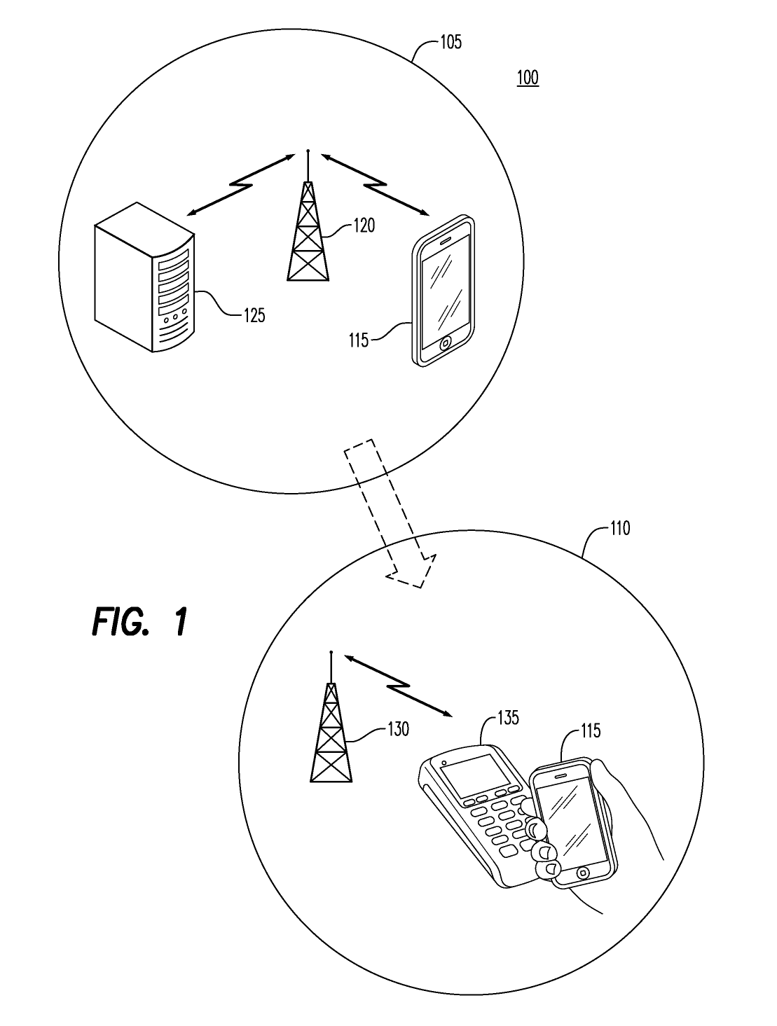

FIG. 1 is an illustrative diagram of a system 100 that includes illustrative devices and systems that may be utilized for supporting a mobile device operative as a contactless payment device that facilitates cross-border payment transactions. System 100 includes a mobile device 115 having mobile telephony functionality. In some embodiments, mobile device 115 may be a mobile or cellular telephone, while in other embodiments of mobile device 115 may be any device having, as one of the one or more of the functions thereof, mobile telephony.

Mobile device 115 may be operable in a first region 105 and a second region 110. In the example of FIG. 1, the first region 105 may correspond to a geographic region or country that uses a first currency in that particular region's or country's monetary system. The second region 110 may correspond to a second geographic region or country that uses a second currency in the region or currency thereof. Wireless mobile communication for mobile device 115 in the first region 105 may be supported by a first mobile network operator (e.g., a “telco”) generally represented at 120. Wireless mobile communication for mobile device 115 in the second region 110 may be supported by mobile network operator communication company provider represented at 130.

It should be appreciated that, in an effort to maintain clarity and conciseness in the drawings herein, mobile network operators 120 and 130 may each include a number of systems, sub-systems, and devices not specifically shown in FIG. 1. The particular embodiments and capabilities of the “telcos” 120 and 130 are not intended to be limited by the features of the present disclosure. For example, the systems, devices, frequencies, communication protocols, power, and other aspects of “telcos” 120 and 130 may include any and all practicable devices and/or values now known and those that become known in the future.

In accordance with some wireless communication systems and mobile network operators, mobile device 115 is “registered” with mobile network operator 120 while operating in region 105 and is registered with mobile network operator 130 when operating in region 110. Thus, the mobile communication service for mobile device 115 is supported by mobile network operator 120 in region 105, whereas the mobile communication service for mobile device 115 is provided by mobile network operator 130 in region 110. The registration and hand-off or transfer of the mobile device's registration between the mobile network operators may be handled automatically, manually, and semi-automatically between mobile network operators (e.g., 120 and 130) as mobile device 115 is moved between, for example, region 105 to region 110.

In order to support and provide communication services to mobile device 115 in a given region or country, the mobile device is registered with the appropriate mobile network operator servicing that region or country. In the example of FIG. 1, region or country 105 may be the home country for mobile device 115. As such, a user may initiate a customer-service provider relationship with mobile network operator 120, wherein mobile device 115 may be initially registered with (home) mobile network operator 120 and the user is billed for mobile communication service by mobile network operator 120. Mobile device 115 may subsequently be registered with mobile network operator 130 for service therefrom when mobile device 115 relocates to region 110. Additionally, mobile network operator 130 may provide a notification to mobile network operator 120 when mobile device 115 is operating in region 110 and registered with mobile network operator 130. The notification from mobile network operator 130 to mobile network operator 120 may be provided to support proper and efficient billing arrangements between the two mobile network operators. Accordingly, “home” mobile network operator 120 for mobile device 115 may be notified when mobile device 115 is registered with another mobile network operator (e.g., 130).

In some embodiments, mobile device 115 may include functionality to operate as a contactless or proximity payment device. Accordingly, mobile device 115 may include, for example, a radio frequency identification (RFID) or near field communication (NFC) device or system that uses radio waves to transfer data from the mobile device to a nearby reader or terminal. In some embodiments herein, a mobile device may include functionality to be operated as a stored value payment device where an amount (i.e., value) of monetary funds is stored on the mobile device. The monetary value (and other data) is stored on the mobile device and can be used in offline only payment transactions where communication to an external or central server or payment network is not required since the monetary value (and other data) available for use in a payment transaction is stored on the mobile device itself. Some examples of a use case for a contactless stored value payment device include transit systems and other payment environments where a payment infrastructure may be lagging or even nonexistent.

In some embodiments, a mobile device herein may include functionality to operate as a contactless stored value payment device. Such functionality may be provided by software, hardware, and a combination of software and hardware elements, components, and systems of the mobile device. For example, an application or “app” executing on mobile device 115 may provide functionality for the mobile device to operate as a contactless stored value payment device. The contactless stored value payment device application and the contactless stored value payment account associated therewith may be provisioned to mobile device 115 by an issuer 125. Issuer 125 may be a financial institution, an entity acting on behalf of a financial institution, a financial service provider, or other entities. In the illustration of FIG. 1, issuer 125 is generally represented by a computer server, although issuer 125 is not limited to embodiments that include one or more servers.

In some aspects, the functionality and/or security aspects of the mobile device to operate as a contactless stored value payment device may be included in, at least in part, a “secure element” of the mobile device. In some instances, the “secure element” may be implemented in an embedded integrated circuit (IC) of the mobile phone or a NFC chip of a subscriber identity module (SIM) or microSD card.

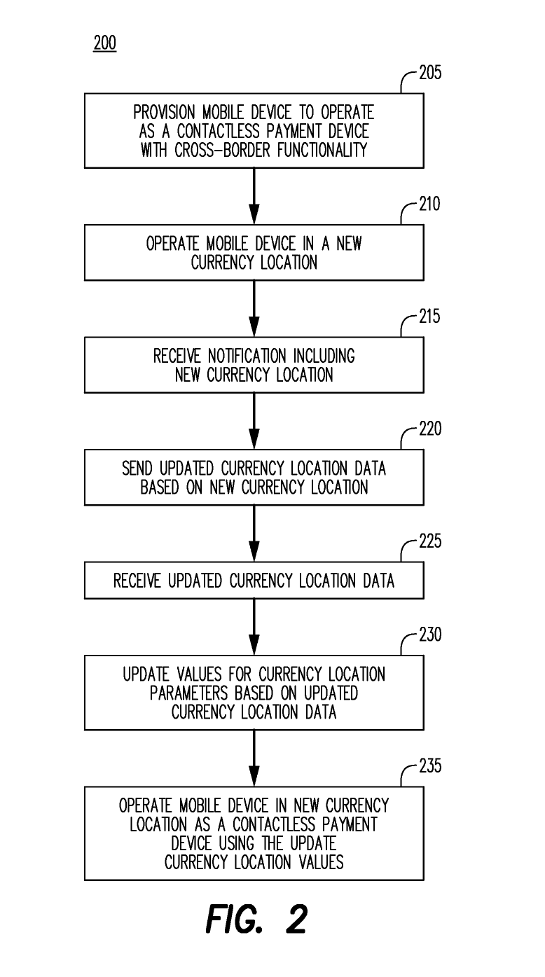

It should be appreciated that the number, type, and arrangement of the devices and systems shown in FIG. 1, like other illustrative figures herein, may vary and do not indicate a fixed configuration of the devices and systems that may be used to implement the methods and processes disclosed herein. Additionally, the illustrative communication flows shown in FIG. 2, and other drawings and flow diagrams herein, are not meant to convey either an exhaustive representation or fixed order of communication messages, requests/responses, and operations between the disclosed devices and systems.

Mobile device 115 may have a user interface (UI) for presenting information to a user and receiving user inputs from a user. In the example of mobile device 115, the UI may include a graphical user interface presenting a number of graphical elements, including an icon representing a wallet or “e-purse” application or “app” (not shown). In some embodiments, mobile device 115 may be a mobile telephone, a personal media player, a tablet, a laptop, a personal computer, and other computing devices including, in general, a processor for executing program instructions. Mobile device 115 may generally include a processor for executing program instructions and code that may be stored on any tangible media, including a medium either integrated or removably interfaced with the mobile device 115. In some aspects, the wallet or e-purse may be provided as a built-in app delivered with mobile device 115 from a device manufacturer and/or a service provider (e.g., a mobile network operator). In some embodiments, the wallet app may be obtained from a third-party such as an “app store”, an application developer, a financial institution (e.g., a payment account issuer or service provider), and other entities.

A wallet or e-purse app associated with a contactless stored value payment device may be invoked by selecting or opening wallet representation or icon on the UI of mobile device 115. The wallet app may be opened in response to a user input, where mobile device 115 may accept touch, voice, and motion based user inputs via one or more keys, touch screens, microphones, and other sensors (e.g., accelerometers, optical sensors, gyroscopes, etc.). In some aspects, these and other input devices of mobile device 115 may combine, with or without executable program instructions, to provide location or context based activation and operation of the processes discussed herein.

In some aspects, a wallet or e-purse app is deployed or otherwise provisioned to mobile device 115 by an issuer 125 of a contactless stored valued payment device representation(s) stored at mobile device 115 or an entity such as a service provider acting on behalf of the issuer. In some embodiments herein, mobile device 115 is enabled for use in contactless payment systems using proximity payment devices and proximity payment readers to securely exchange purchase transaction data.

FIG. 2 is a flow diagram conveying various aspects of an overall process 200 in accordance with some embodiments herein. Process 200 may be carried out or supported by the system depicted in FIG. 1. It is however noted that process 200 is not limited or restricted to being implemented, either in whole or part, by system 100. For the purpose of providing context, process 200 will be discussed with reference to the system and devices depicted in FIG. 1.

At operation 205, a mobile device is provisioned to a user. The mobile device is provisioned, deployed, or otherwise actuated to enable it to operate as a contactless payment device. In some aspects, an issuer (e.g., issuer 125) of a stored value account or other account may issue mobile device 115 enabled to operate as a contactless payment device or a component that interacts with the mobile device to enable the contactless payment device functionality (e.g., an application or module). Mobile device 115 may be provisioned to a user (not shown) that resides in region 105. In some embodiments, the issuer may be the assignee hereof, MasterCard International Incorporated.

In some embodiments, the mobile device may be “personalized” with data that facilitates the operation of the mobile device 115 as a contactless payment device for the particular user. For example, the data to “personalize” mobile device 115 may include a value for the amount of currency to store on the mobile device. The value of the currency stored on the phone will be the amount of funds available for use by the contactless payment device in a payment transaction. In some embodiments, the issuer may be the assignee hereof, MasterCard International Incorporated. In some aspects, mobile device 115 is initially deployed to operate in a first region 105 based on a first currency.

In accordance with some embodiments herein, the mobile device may be provisioned to operate as a contactless payment device including cross-border functionality. As used herein, the “cross-border” functionality implies the contactless payment device may operate as a contactless payment device across borders of different regions having different currencies and monetary systems. As also used herein, a currency location refers to a location, region, country, or other area having a monetary system that uses a specific currency. It should be appreciated that different currency locations may have different currencies where each currency may have an associated set of attributes such as, for example, denominations, valuations, exchange rates, etc. In the example of FIG. 1, region 105 and region 110 have distinct and different currencies. Accordingly, region 105 and region 110 are each referred to as a currency location herein.

At operation 210, mobile device 115 is relocated to and operated in a new region such as, for example, region 110. As indicated at operation 215 in FIG. 2, mobile device 115 is operated in a new currency location. Referring to FIG. 1, the new currency location may be region 110. Upon being operated in region 110 or some time thereafter, issuer 125 receives a notification that includes an indication of the new currency location corresponding to the current location of mobile device 115.

Based on the notification including the new currency location of mobile device 115, updated currency location data is sent to mobile device 115 at operation 220. The updated currency data is provided to update or otherwise modify aspects of mobile device 115 so that the mobile device may accurately operate as a contactless payment device in region 110. At operation 225, the mobile device 115 receives the updated currency location data.

The updated currency location data received at operation 225 may be used to update parameters of the mobile device such that mobile device 115 may operate, efficiently and accurately, in the new currency location of region 110. At operation 230, values for currency location parameters for region 110 may be updated. As noted in FIG. 2, operation 230, the values for the currency location parameters are updated based on the updated currency location data received at operation 225. Continuing to operation 235, mobile device 115 may be operated as a contactless payment device in the new currency location of region 110. In some aspects, mobile device 115 may use the updated currency location values of operation 230 to ensure the contactless payment device functionality of the mobile device is accurate.

As a simplified example, the currency location data received at operation 225 may include an exchange rate to convert the value of the currency stored on the mobile device and corresponding to region 105 to the currency of region 110. Thus, mobile device 115 may be enabled to effectively and efficiently operate in the new currency location of region 110 by having the value of the currency stored on the phone converted to an appropriate value for the currency of the new currency location (e.g., currency location 110). In some embodiments, operations 210 and 215 may be automatically performed without intervention or initiation of a user.

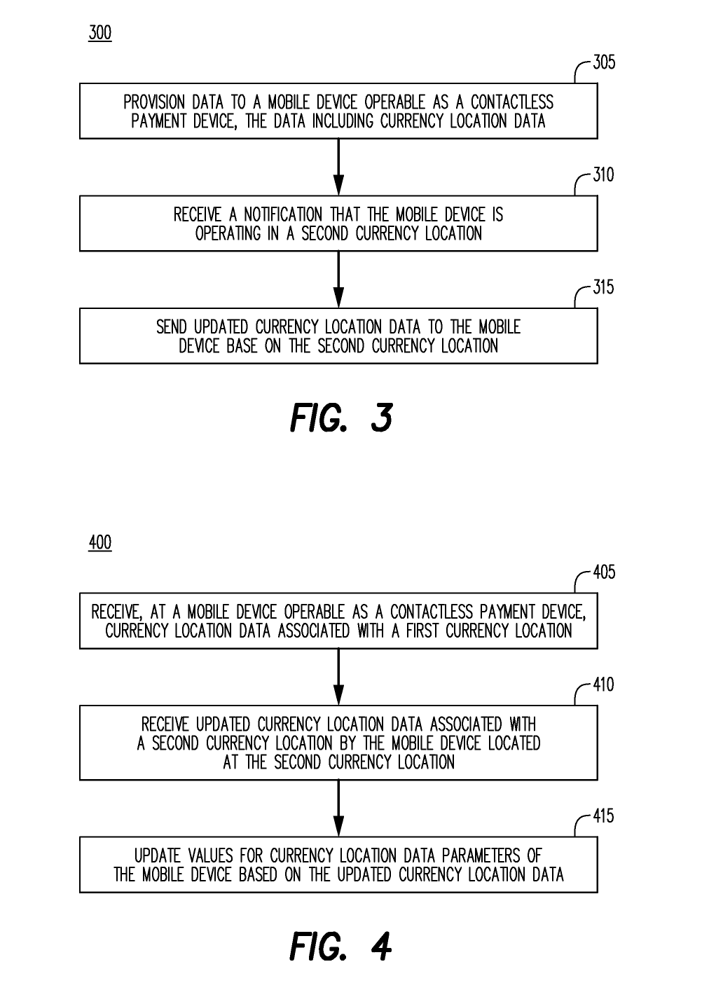

FIG. 3 is a flow diagram including operations related to a process 300. In some aspects, process 300 may relates to a process of an issuer. At operation 305, the issuer provisions or deploys a mobile device personalized to operate as a contactless payment device. In some aspects, the issuer may provide data, an application, or module (e.g., a SIM card) that interacts or interfaces with mobile device 115 that effectively personalizes the mobile device to operate as a contactless payment device for an intended user. In some aspects, the contactless payment device may be associated with stored value account of the user. In accordance with aspects herein, the mobile device may be provisioned to operate across multiple currency locations (i.e., cross-border).

In some embodiments, the data to personalize the mobile device as a contactless payment device may include, for example, a first currency code that provides an indication of a currency of a first or home currency location; a second or cross-border code that provides an indication of a currency of a second currency location; an exchange rate related to the first currency and the second currency; and an indication of the amount or value of the funds to associate with the contactless payment device.

In some embodiments, the first currency code, the second currency code, and the exchange rate may be set to default values. For example, at an initialization of the contactless payment device (or other times thereafter), the default value for the first currency code may be set to the home currency for the mobile device (e.g., for a home region of Singapore the currency code is SGD for the Singapore dollar) and the second currency code may be set to match the first currency code (i.e., SGD) since the mobile device has yet to be moved to a second currency location. Also, the value for the exchange rate may be set to “1” by default since the default values for the first and second currency locations are the same in this example. It should be appreciated that other initialization and other default values for the currency location parameters herein may be established in accordance with the present disclosure.

At operation 310, the issuer may receive a notification that mobile device 115 is operating in a new currency location. A new currency location implies a new or different currency than the one the mobile device 115 is currently configured to use. In some aspects, the notification itself may include a direct indication of the currency of the new currency location. In some aspects, the issuer may have to calculate or otherwise determine at least some aspects of the currency related to the new currency location based on the data received in the notification at operation 310. For example, the notification may indicate mobile device 115 is in a new location and provide the longitude and latitude corresponding to the mobile device's current location in the new currency location. The issuer may, in some embodiments, determine the currency that correlates to the current location of the mobile device.

At operation 315, the issuer may send updated currency data to mobile device 115. It is noted that the updated currency data may be determined based, at least in part, on the new currency location received in the notification of operation 310. In some embodiments, the issuer 125 may send a “script”, message, or other data to the mobile network 130 via mobile network operator 120. In some aspects, the notification may include the cross-border or second currency location code and the exchange rate. In some aspects, issuer 125 may use external sources to determine the updated currency data of operation 315. For example, an exchange rate to convert between a first currency and a second currency may be obtained from an external source such as a bank or other financial market data.

FIG. 4 includes a depiction of a flow diagram for a process 400. Process 400 may relate to a process of a mobile device, in accordance with some aspects herein. At operation 405, the mobile device 115 may receive currency location data for a first or home currency location. The currency location data my include values for the first or home currency location code, a second or cross-border currency location code, an exchange rate, and a value or amount of funds. In some aspects, operation 405 may relate to an initialization of mobile device 115 to operate as a contactless payment device.

At operation 410, the mobile device may be located at a second currency location and receive updated currency location data associated with the second currency location. The updated second currency location data may include a currency code for the second or cross-border currency location and an applicable exchange rate. The exchange rate may be based on the first currency location code and the second currency location code. As an example, the first currency location may correspond to Singapore and have a currency code of SGD. The second currency may correspond to Australia and have a currency code of AUD (i.e., the Australian dollar). This example may further include an exchange rate of $1.0 AUD=$1.3 SGD.

At operation 415, the mobile device 115 or a component thereof may update values for currency location data parameters of the mobile device. The values for the currency location data parameters of the mobile device may be based on the updated currency location data received at operation 410. In this manner and as an example, a mobile device having a value of $100 SGD stored thereon would have an updated value of $77 AUD for the updated currency location data including the exchange rate of $1.0 AUD=$1.3 SGD.

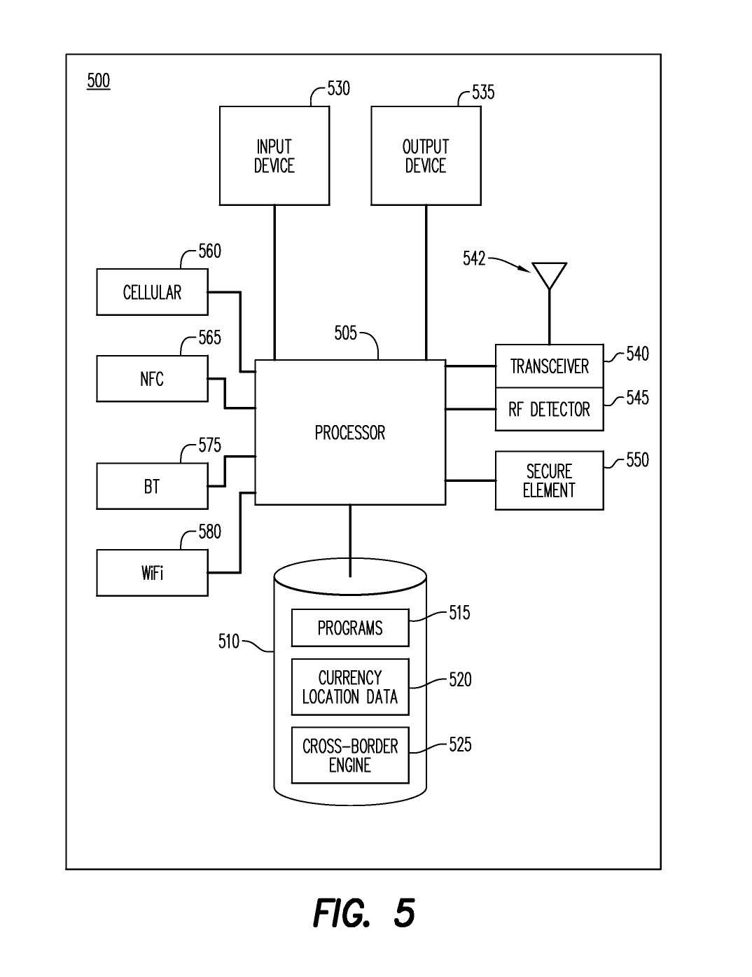

FIG. 5 is a block diagram of an apparatus, device, or system for a multifunctional mobile device 500 including a mobile or cellular telephone capability and a short-range wireless communication capability. FIG. 5 does not imply or necessarily represent a physical layout of mobile device 500. In its hardware and in some of its software/firmware, mobile device 500 may be substantially conventional. However, mobile device 500 may include hardware, software, firmware, and combinations thereof to implement and embody aspects of the present disclosure, including the methods and processes herein.

Mobile device 500 may include a conventional housing (not explicitly shown) that contains and/or supports the other components of the mobile telephone. The housing may, for example, be shaped and sized so as to be held in the user's hand. In some embodiments, device 500 may be housed in a device such as a tablet computing device and other form factors.

Mobile device 500 may include a processor 505 that processes and controls data in the mobile device that is interfaced with a memory 510 and capable of executing program instructions 515 stored in memory 510, a transceiver 540 for transmitting and receiving communication signals to and from antenna 542, and a RF detector 545 comprising part of the transceiver for detecting RF signals. Though not separately depicted in FIG. 5, memory 510 may include or encompass, in various embodiments, random access memory (RAM), read only memory (ROM), a SIM card, flash memory, and other types and forms of data storage devices and media. The processes disclosed herein may be implemented by the components of mobile device 500. For example, currency location data 520 and a computer-executable code including cross-border engine 525 may be executed under the control of processor 505 and programs 505 to effectuate the processes disclosed herein.

Transceiver 540 may be coupled to antenna 542 and connects to the communication channel(s) by which mobile telephone 500 communicates via a mobile network (not shown). The transceiver is in communication with antenna 542 that may serve to transmit and receive wireless wide-range and short-range communication signals. Mobile telephone 500 may also include an input device 530 (e.g., a keypad, keyboard, touchscreen system, voice input components, etc.) for receiving inputs from a user, and an output device 535 (e.g., a speaker, an indicator light, a display, etc.) for providing an output of the mobile telephone to the user or other entities.

In conventional fashion, transceiver 540 operates to transmit, via antenna 542, voice signals received from a user through input device 530, and operates to reproduce, via output device 535 (e.g., a speaker), voice signals received via antenna 542. Transceiver 540 may also further operate to handle transmission and reception of text messages and/or other data communications via antenna 542. In some embodiments, mobile telephone 500 may transmit wireless communication signals in any frequency range and power, including those now used and those that may be used in the future without limit such as, for example, GSM 1900/1800/850 MHz, and other frequencies at a maximum transmit power of about 30 dBM, 33 dBM, and the like.

Mobile telephone 500 may be capable of communicating with another device via cellular telephone signals as provided by a cellular component or module 560 and a variety of short-range communication protocols, such as and by NFC signals as provided by NFC module or components 565 or the like, Bluetooth® as provided by a Bluetooth® module 575, and by a wireless local area network (e.g., Wi-Fi, based on IEEE 802.11 b/g/n or other standards) as provided by a Wifi module 580.

In some embodiments, mobile telephone 500 may be a NFC-enabled mobile telephone equipped to operate as a secure proximity payment device and interact/communicate with another device (not shown in FIG. 5) such as a ticket kiosk/device and a contactless-POS terminal or other device that may include a radio frequency identification (“RFID”) tag. In some embodiments, the contactless-POS or other device and mobile telephone 500 may typically be positioned in close proximity of each other when communicating using NFC signals. In some aspects, the contactless-POS or other device and mobile telephone 805 may be within about 0-10 millimeters of each other in order for a RF power field generated by either the mobile telephone and the contactless-POS terminal or other device to transfer data therebetween.

It is noted that the short-range communication platform used for communication between mobile telephone 500 and other devices may be any acceptable platform operating in any acceptable frequency band. For example, Bluetooth® or WLAN communications that operate in the 2.4 GHz frequency band, may be implemented. Communication is not however limited to the 2.4 GHz frequency band and may include communication in the 900 MHz frequency band, the 5.8 GHz frequency band, the 13.56 MHz frequency band or the like.

In some embodiments, the methods and processes herein, including the functionality and operation of a mobile device or other wireless communication mobile device in accordance with the methods and processes herein may be included, supplied, or otherwise provisioned with the mobile telephone or other wireless communication mobile device to operate independently of any other features of the mobile telephone or other wireless communication mobile device. In some aspects, at least some aspects of the mobile device's functionality to operate as a contactless payment device may be stored or located in secure element 550. The configuration of secure element 550 may be provided in conformance with one or more industry “standards”.

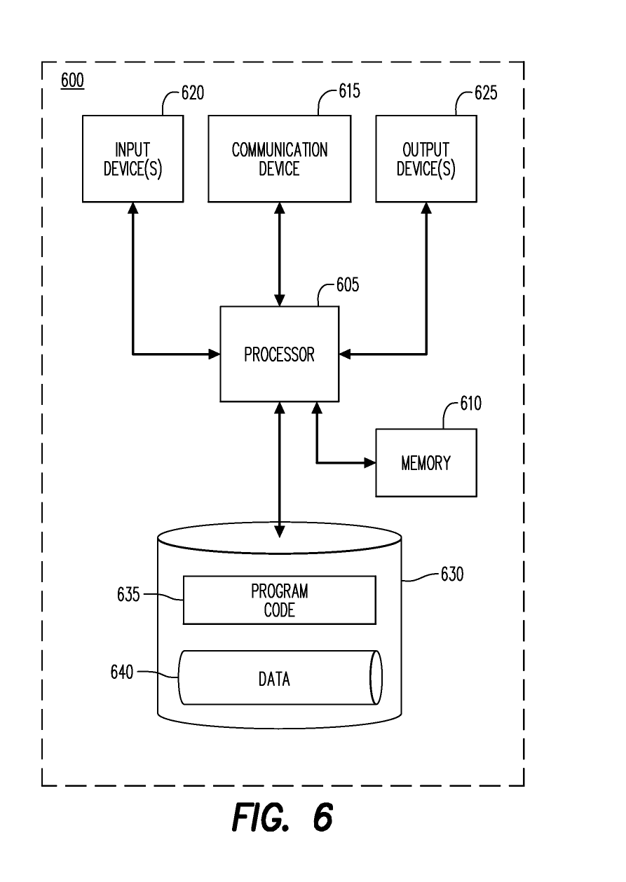

FIG. 6 is a block diagram overview of a system or apparatus 600 according to some embodiments. System 600 may be, for example, associated with any of the devices described herein, including for example a merchant POS device 135 and an application server supporting or providing an issuer 125. The system 600 comprises a processor 605, such as one or more commercially available Central Processing Units (CPUs) in the form of one-chip microprocessors or a multi-core processor, coupled to a communication device 615 configured to communicate via a communication network (not shown in FIG. 6) to another device or system. In the instance system 600 comprises a server (e.g., supporting the functions and services provided by issuer 125), communication device 615 may provide a means for system 600 to interface with a client device. Device 600 may also include a local memory 610, such as RAM memory modules. The system 600 further includes an input device 620 (e.g., a touchscreen, mouse and/or keyboard to enter content) and an output device 625 (e.g., a computer monitor to display a user interface element).

Processor 605 communicates with a storage device 630. Storage device 630 may comprise any appropriate information storage device, including combinations of magnetic storage devices (e.g., a hard disk drive), optical storage devices, and/or semiconductor memory devices. In some embodiments, storage device may comprise a database system.

Storage device 630 stores program code 635 that may provide computer executable instructions for processing notifications from, for example, a network operator in accordance with processes herein. Processor 605 may perform the instructions of the program code 635 to thereby operate in accordance with any of the embodiments described herein. Program code 635 may be stored in a compressed, uncompiled and/or encrypted format. Program code 635 may furthermore include other program elements, such as an operating system, a database management system, and/or device drivers used by the processor 605 to interface with, for example, peripheral devices. Storage device 630 may also include data 645 such as database records or look-up tables. Data 645 may be used by system 600, in some aspects, in performing the processes herein, including the determining of currency location codes and exchange rates.

All systems and processes discussed herein may be embodied in program code stored on one or more computer-readable media. Such media may include, for example, a floppy disk, a CD-ROM, a DVD-ROM, magnetic tape, and solid state Random Access Memory (RAM) or Read Only Memory (ROM) storage units. According to some embodiments, a memory storage unit may be associated with access patterns and may be independent from the device (e.g., magnetic, optoelectronic, semiconductor/solid-state, etc.) Moreover, in-memory technologies may be used such that databases, etc. may be completely operated in RAM memory at a processor. Embodiments are therefore not limited to any specific combination of hardware and software.

Embodiments have been described herein solely for the purpose of illustration. Persons skilled in the art will recognize from this description that embodiments are not limited to those described, but may be practiced with modifications and alterations limited only by the spirit and scope of the appended claims.

1. A computer-implemented method, the method comprising:
provisioning data to personalize a mobile device operable as a contactless payment device, the data including currency location data, the provisioned data including an indication of a first currency, a second currency, an exchange rate related to both the first currency and the second currency, and an amount of available funds to store on the mobile device for use with the contactless payment device;
receiving, automatically and without user intervention, a notification that the mobile device is operating in a second currency location; and
sending updated currency location data to the mobile device based on the second currency location received in the notification.

2. The method of claim 1, wherein the provisioned data enables the mobile device to operate as a contactless stored valued payment device.

3. The method of claim 1, wherein the data is stored in a secure element of the mobile device.

4. (canceled)

5. The method of claim 1, wherein the updated currency location data includes at least (1) an indication of a currency associated with the second currency location and (2) an exchange rate related to the first currency and the second currency.

6. A computer-implemented method, the method comprising:
receiving, to personalize a mobile device operable as a contactless payment device, currency location data associated with a first currency location, the received currency location data including an indication of a first currency, a second currency, an exchange rate related to both the first currency and the second currency, and an amount of available funds for use with the contactless payment device;
receiving updated currency location data associated with a second currency location by the mobile device located at the second currency location; and
updating values for currency location data parameters of the mobile device based on the updated currency location data.

7. The method of claim 6, wherein the first currency location and the second currency locations are associated with different currencies.

8. The method of claim 6, wherein the currency location data and the updated currency location data are stored in a secure element of the mobile device.

9. (canceled)

10. The method of claim 6, wherein the updated currency location data includes at least (1) an indication of a currency associated with the second currency location and (2) an exchange rate related to the first currency and the second.

11. The method of claim 6, wherein the mobile device is to operate as a contactless stored valued payment device.

12. An apparatus comprising:
a processor; and
a memory device in communication with the processor and storing program instructions thereon, the processor operative with the program instructions to:
provision data to personalize a mobile device operable as a contactless payment device, the provisioned data including currency location data, the provisioned data including an indication of a first currency, a second currency, an exchange rate related to both the first currency and the second currency, and an amount of available funds to store on the mobile device for use with the contactless payment device;
receive, automatically and without user intervention, a notification that the mobile device is operating in a second currency location; and
send updated currency location data to the mobile device based on the second currency location received in the notification.

13. The apparatus of claim 12, wherein the provisioned data enables the mobile device to operate as a contactless stored value payment device.

14. The apparatus of claim 12, wherein the data is stored in a secure element of the mobile device.

15. (canceled)

16. The apparatus of claim 12, wherein the updated currency location data includes at least (1) an indication of a currency associated with the second currency location and (2) an exchange rate related to the first currency and the second currency.

17. An apparatus comprising:
a processor; and
a memory device in communication with the processor and storing program instructions thereon, the processor operative with the program instructions to:
receive, to personalize at a mobile device operable as a contactless payment device, currency location data associated with a first currency location, the received currency location data including an indication of a first currency, a second currency, an exchange rate related to both the first currency and the second currency, and an amount of available funds for use with the contactless payment device;
receive updated currency location data associated with a second currency location by the mobile device located at the second currency location; and
update values for currency location data parameters of the mobile device based on the updated currency location data.

18. The apparatus of claim 17, wherein the first currency location and the second currency locations are associated with different currencies.

19. The apparatus of claim 17, wherein the currency location data and the updated currency location data are stored in a secure element of the mobile device.

20. (canceled)

21. The apparatus of claim 17, wherein the updated currency location data includes at least (1) an indication of a currency associated with the second currency location and (2) an exchange rate related to the first currency and the second.

22. The apparatus of claim 17, wherein the mobile device is to operate as a contactless stored valued payment device.
